(19) United States
(12) Patent Application Publication
(10) Pub. No.: US 2024/0412490 A1
(43) Pub. Date: Dec. 12, 2024

(54) METHOD FOR TRANING A PEDESTRIAN DETECTION MODEL, PEDESTRIAN DETECTION METHOD, ELECTRONIC DEVICE, AND COMPUTER-READABLE STORAGE MEDIUM

(71) Applicant: Shenzhen Reolink Technology Co., Ltd., Shenzhen (CN)

(72) Inventors: Yanchong Chai, Shenzhen (CN); Qingjie Chen, Shenzhen (CN); Jun Zhang, Shenzhen (CN); Guobin Lin, Shenzhen (CN)

(21) Appl. No.: 18/810,992

(22) Filed: Aug. 21, 2024

(30) Foreign Application Priority Data
Sep. 20, 2023 (CN) 202311223081.7

(51) Int. Cl. G06V 10/774; G06V 10/77; G06V 10/776; G06V 10/82; G06V 20/52; G06V 40/10

(52) U.S. Cl. CPC G06V 10/774; G06V 10/7715; G06V 10/776; G06V 10/82; G06V 40/10; G06V 20/52

(57) ABSTRACT

This application provides a pedestrian detection method, a method for training a pedestrian detection model, an electronic device, and a computer-readable storage medium. The pedestrian detection method includes: acquiring an image to be recognized; inputting the image into a multi-task recognition network to acquire a predicted pedestrian location and a predicted pedestrian attribute in parallel; and correlating the predicted pedestrian location and the predicted pedestrian attribute to output a detection result. The pedestrian detection method utilizes the multi-task recognition network to acquire the predicted pedestrian location and the predicted pedestrian attribute in parallel, and the detection result containing the predicted pedestrian location and the predicted pedestrian attribute is acquired only by inputting the image to be recognized once, thereby improving detection efficiency, quickly obtaining the detection result and saving device resources.

### TECHNICAL FIELD

This application relates to the technical field of artificial intelligence, and more particularly relates to a pedestrian detection method, a method for training a pedestrian detection model, an electronic device, and a computer-readable storage medium.

### BACKGROUND

With the development of artificial intelligence, pedestrian detection has been widely applied in various fields. In the current pedestrian detection methods, a target detection algorithm is mostly utilized to achieve detection so as to recognize a pedestrian location in an image. In some application scenarios, in addition to location information of a pedestrian, it is also necessary to acquire attribute information of the pedestrian, and the attribute information of the pedestrian may simply include elements such as gender, age, body type and dressing of the pedestrian.

However, in the current methods for acquiring a pedestrian attribute, it is generally necessary to firstly acquire a location detection result of the pedestrian to clip a corresponding pedestrian target image according to the location detection result of the pedestrian, and then input the pedestrian target image into a pedestrian attribute recognition network for recognition. In this detection mode, it is necessary to utilize two or more neural network models to calculate the pedestrian location and the pedestrian attribute, respectively, so that device resources required for calculation are relatively enormous.

### SUMMARY

This application provides a pedestrian detection method, a method for training a pedestrian detection model, an electronic device, and a non-transitory computer-readable storage medium.

In one aspect, this application provides a pedestrian detection method. The pedestrian detection method includes: acquiring an image to be recognized; inputting the image to be recognized into a pre-trained multi-task recognition network, the multi-task recognition network including a backbone network, a pedestrian detection network and an attribute recognition network; acquiring a backbone feature map according to the input image to be recognized based on the backbone network; acquiring a predicted pedestrian location according to the backbone feature map based on the pedestrian detection network; acquiring a predicted pedestrian attribute according to the backbone feature map based on the attribute recognition network; and correlating the predicted pedestrian location and the predicted pedestrian attribute to output a detection result.

In another aspect, this application provides a method for training a pedestrian detection model. The method includes: constructing a multi-task recognition network, the multi-task recognition network including a backbone network, a pedestrian detection network and an attribute recognition network; acquiring a training set image; and inputting the training set image into the multi-task recognition network for training to obtain the pedestrian detection model; wherein the backbone network is used for acquiring a backbone feature map according to the input training set image, the pedestrian detection network is used for acquiring a predicted pedestrian location according to the input backbone feature map, and the attribute recognition network is used for acquiring a predicted pedestrian attribute according to the input backbone feature map.

In yet another aspect, this application provides an electronic device which includes a memory and a processor. The memory is configured to store a plurality of computer program instructions. The processor is configured to execute the computer program instructions stored in the memory to perform the pedestrian detection method, or perform the method for training a pedestrian detection model.

In still another aspect, this application further provides a non-transitory computer-readable storage medium having a plurality of computer program instructions, wherein the program instructions, when executed by one or more processors, causes the one or more processors to implement the pedestrian detection method or the method for training a pedestrian detection model as described above.

The pedestrian detection method provided in this application may utilize the multi-task recognition network to acquire the predicted pedestrian location and the predicted pedestrian attribute in parallel, and the detection result containing the predicted pedestrian location and the predicted pedestrian attribute may be acquired only by inputting the image to be recognized once, thereby improving the detection efficiency, quickly obtaining the detection result and saving device resources.

### BRIEF DESCRIPTION OF THE DRAWINGS

The foregoing and/or additional aspects and advantages of this application will become apparent and be readily understood from the description of the embodiments in conjunction with the following accompanying drawings, in which:

FIG. 1 is a schematic flowchart of a pedestrian detection method according to an embodiment of this application;

FIG. 2 is a schematic structural diagram of a multi-task recognition network according to an embodiment of this application;

FIG. 3 is a schematic structural diagram of a pedestrian detection apparatus according to an embodiment of this application;

FIG. 4 is a schematic structural diagram of a first task head network according to an embodiment of this application;

FIG. 5 is a schematic structural diagram of a second task head network according to an embodiment of this application;

FIG. 6 is a schematic scenario diagram of pedestrian detection according to an embodiment of this application;

FIG. 7 is a schematic flowchart of a method for training a pedestrian detection model according to an embodiment of this application;

FIG. 8 is a schematic structural diagram of an apparatus for training a pedestrian detection model according to an embodiment of this application;

FIG. 9 is a schematic structural diagram of an electronic device according to an embodiment of this application; and

FIG. 10 is a schematic diagram of a connection state of a computer-readable storage medium and a processor according to an embodiment of this application.

### DETAILED DESCRIPTION OF EMBODIMENTS

Embodiments of this application will be described in detail below, and examples of the embodiments are illustrated in the accompanying drawings, wherein same or similar reference numerals refer to same or similar elements, or elements with same or similar functions throughout the drawings. The embodiments described below with reference to the accompanying drawings are exemplary only to explain the embodiments of this application and should not be construed as limiting the embodiments of this application.

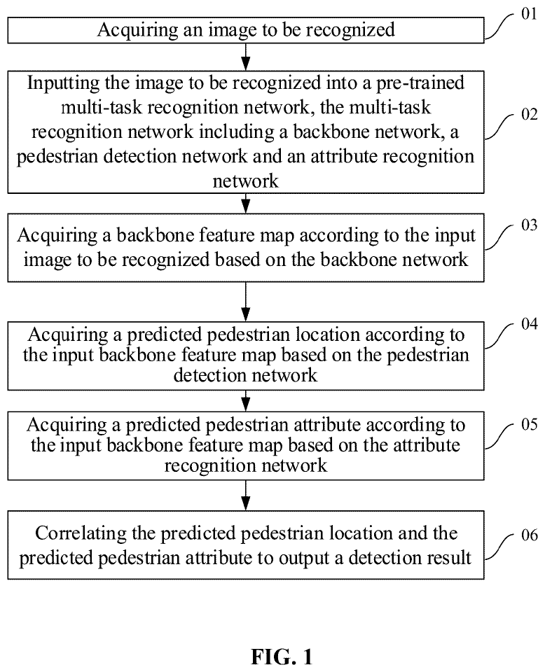

FIG. 1 is schematic flowchart of a pedestrian detection method according to an embodiment of this application. The pedestrian detection method simultaneously performs pedestrian detection and human attribute recognition by utilizing a multi-task recognition network through multi-task learning, so as to save device resources and improve the recognition efficiency. In the embodiment, a method for training a portrait detection model includes the following steps in detail.

Step 01: acquiring an image to be recognized.

Step 02: inputting the acquired image to be recognized into a pre-trained multi-task recognition network, the multi-task recognition network including a backbone network, a pedestrian detection network and an attribute recognition network.

Step 03: acquiring a backbone feature map according to the input image to be recognized based on the backbone network.

Step 04: acquiring a predicted pedestrian location according to the backbone feature map based on the pedestrian detection network.

Step 05: acquiring a predicted pedestrian attribute according to the backbone feature map based on the attribute recognition network.

Step 06: correlating the predicted pedestrian location and the predicted pedestrian attribute to output a detection result.

The image to be recognized is an image requiring pedestrian detection. No matter whether a pedestrian is actually contained in the image to be recognized, the image may be input into the multi-task recognition network as the image to be recognized. If the image to be recognized contains the pedestrian, the multi-task recognition network may output a corresponding detection result, and the detection result includes a pedestrian location and a pedestrian attribute. If the image to be recognized does not contain the pedestrian, the multi-task recognition network may also output a corresponding detection result, and the detection result may indicate that the image to be recognized does not contain the pedestrian, wherein the image to be recognized may be a planar image taken by an ordinary lens camera, and an image frame extracted from a video, or may also be a fisheye image with a certain degree of distortion taken by a fisheye lens camera, which is not limited herein. The pre-trained multi-task recognition network may be applicable to pedestrian detection for the fisheye image with a certain degree of rotational distortion after being trained. A method for training the multi-task recognition network provided in this application will be described in detail. In this way, in the application scenarios such as aerial photography of an unmanned aerial vehicle and security and protection monitoring, in which the fisheye lens camera is mostly used for shooting, the pedestrian detection may be performed on the fisheye image by the pedestrian detection method according to the embodiment of this application, with a wider application range.

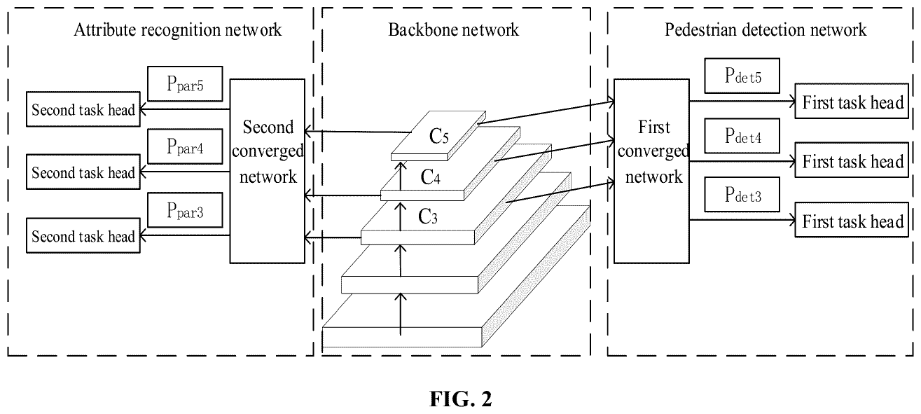

Referring to FIG. 2, the multi-task recognition network is a multi-task learning network in a neural network model, may be simultaneously trained for a recognition task of the pedestrian location and a recognition task of the pedestrian attribute during training, and may learn potential connection between the pedestrian location and the pedestrian attribute. The trained multi-task recognition network may acquire the predicted pedestrian location and the predicted pedestrian attribute in parallel based on the input image to be recognized. The multi-task recognition network includes a backbone network, a pedestrian detection network and an attribute recognition network, wherein the backbone network is configured for acquiring a backbone feature map according to the input image to be recognized, the pedestrian detection network is configured for acquiring a predicted pedestrian location according to the backbone feature map, and the attribute recognition network is configured for acquiring a predicted pedestrian attribute according to the backbone feature map.

The pedestrian detection network and the attribute recognition network are respectively used for executing a task of pedestrian location prediction and a task of pedestrian attribute prediction, and the two task networks of the pedestrian detection network and the attribute recognition network share the same backbone network and both take the backbone feature map output by the backbone network as input. In this way, the multi-task recognition network may acquire prediction results of the two tasks of pedestrian location prediction and pedestrian attribute prediction based on the same image to be recognized.

The multi-task recognition network is a feature extraction network, for example, the multi-task recognition network may be the feature extraction network of a network model such as Darknet, resnet50, VGG16, and the like. The backbone network is used for extracting pedestrian features from the image to be recognized, and the backbone feature map is an extracted pedestrian feature map. Both the pedestrian detection network and the attribute recognition network take the same backbone feature map as input, so that the pedestrian detection network and the attribute recognition network acquire the predicted pedestrian location and the predicted pedestrian attribute based on the same pedestrian features, which is beneficial to establishing the correlation between the predicted pedestrian location and the predicted pedestrian attribute in the subsequent processing.

Predicting the pedestrian location includes recognizing whether a pedestrian is present in the image. If the pedestrian is present in the image, location information of the pedestrian is provided, for example, the location information of the pedestrian is provided by means of text annotations, labeling with block diagrams, and the like; and if no pedestrian is present in the image, information that no pedestrian is present in the image is provided when predicting the pedestrian location, for example, the image is not labeled, and for another example, text annotations may be labeled in the image to indicate that no pedestrian is present in the image.

The predicted pedestrian attribute is pedestrian attribute information provided in the case where the pedestrian is present in the image. In one example, the pedestrian attribute information refers to whether the pedestrian has a certain preset attribute. For example, the preset attributes include: male, female, child, youth, adult, elderly, front, side, back, and the like; and based on the preset attributes, the pedestrian attributes are predicted as: male, youth, and front, which means that the pedestrian in the image is a male youth and the body faces front.

The detection result may include pedestrian location information acquired based on the predicted pedestrian location, and pedestrian attribute information acquired based on the predicted pedestrian attribute. Correlating the predicted pedestrian location and the predicted pedestrian attribute means correlating the pedestrian location information and the pedestrian attribute information corresponding to the same pedestrian. For example, the detection result may be that the pedestrian in the image to be recognized is selected in the form of a detection box, and the attribute of the pedestrian is annotated by text near the detection box, and the pedestrian target corresponding to the text annotation and the pedestrian target selected by the detection box are the same pedestrian target. The detection result may also include only the pedestrian location information, for example, only the pedestrian in the image to be recognized is selected in the form of the detection box. The detection result may also include only the pedestrian attribute information, for example, only the attribute of the pedestrian in the image to be recognized is annotated by text, and the location of the text annotation is not limited.

Currently, in the existing pedestrian detection method, if it is necessary to acquire the pedestrian attribute, it is necessary to firstly acquire the pedestrian location, and take the pedestrian location and the image to be recognized as input of a pedestrian attribute detection model to acquire the pedestrian attribute by the pedestrian attribute detection model, while the pedestrian location is acquired by a pedestrian location detection model. The pedestrian location detection model and the pedestrian attribute detection model are independent from each other, and the process of acquiring the pedestrian attribute depends on the output of the pedestrian location, which is a serial process and requires to consume relatively enormous device resources. For example, when the pedestrian location and the image to be recognized are taken as the input of the pedestrian attribute detection model, memory resources and calculation resources of a device are required for consumption to clip a pedestrian image in the image to be recognized according to the pedestrian location as the input of the pedestrian attribute detection model.

Compared with the existing pedestrian detection method, the pedestrian detection method provided in this application may utilize the multi-task recognition network to acquire the predicted pedestrian location and the predicted pedestrian attribute in parallel, and the detection result containing the predicted pedestrian location and the predicted pedestrian attribute may be merely acquired by inputting the image to be recognized once, thereby improving the detection efficiency, quickly obtaining the detection result and saving device resources. Furthermore, the pedestrian detection method provided in this application does not require inputting two or more times as in a serial pedestrian detection method, and does not require additional processing on the image to be recognized based on the detection result of the pedestrian location, so that device resources may be saved.

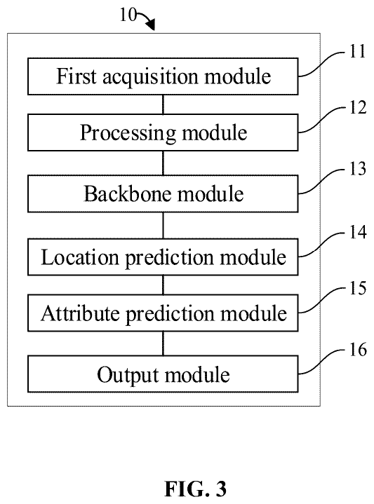

Referring to FIG. 3, an embodiment of this application provides a pedestrian detection apparatus 10. The pedestrian detection apparatus 10 may execute the steps 01, 02, 03, 04, 05, and 06 of the above-described pedestrian detection method to be able to acquire the detection result containing a predicted pedestrian location and a predicted pedestrian attribute of an image to be recognized by utilizing only a multi-task recognition network according to the input single image to be recognized.

The pedestrian detection apparatus 10 includes a first acquisition module 11, a processing module 12, a backbone module 13, a location prediction module 14, an attribute prediction module 15, and an output module 16. The first acquisition module 11 is configured for executing the step 01 of the method, the processing module 12 is configured for executing the step 02 of the method, the backbone module 13 is configured for executing the step 03 of the method, the location prediction module 14 is configured for executing the step 04 of the method, the attribute prediction module 15 is configured for executing the step 05 of the method, and the output module 16 is configured for executing the step 06 of the method. Namely, the first acquisition module 11 is configured to acquire an image to be recognized. The processing module 12 is configured to input the image to be recognized into a pre-trained multi-task recognition network, wherein the multi-task recognition network includes a backbone network, a pedestrian detection network and an attribute recognition network. The backbone module 13 is configured to acquire a backbone feature map according to the input image to be recognized based on the backbone network. The location prediction module 14 is configured to acquire a predicted pedestrian location according to the input backbone feature map based on the pedestrian detection network. The attribute prediction module 15 is configured to acquire a predicted pedestrian attribute according to the input backbone feature map based on the attribute recognition network. The output module 16 is configured to correlate the predicted pedestrian location and the predicted pedestrian attribute to output a detection result.

In this embodiment, a plurality of backbone feature maps are provided, and the plurality of backbone feature maps have different resolutions. In one example, a plurality of backbone feature maps with different resolutions may be acquired by means of down-sampling processing, and accordingly, step 03: acquiring a backbone feature map according to the input image to be recognized based on the backbone network, includes:

Step 031: acquiring at least two backbone feature maps with different resolutions by performing down-sampling processing on the input image to be recognized based on the backbone network.

Correspondingly, the backbone module 13 may also be configured for executing the method in step 031. Namely, the backbone module 13 may also be configured to acquire at least two backbone feature maps with different resolutions by performing down-sampling processing on the input image to be recognized based on the backbone network.

The backbone network may extract backbone feature maps with a plurality of resolution scales from the input image to be recognized. The greater the number of times of down-sampling is, the lower the resolutions of the extracted backbone feature maps are, the backbone feature map with the lower resolution belongs to a higher-level feature map, and contains stronger semantic information, so as to easily detect a larger target object. Similarly, the less the number of times of down-sampling is, the higher the resolutions of the extracted backbone feature maps are, the backbone feature map with the higher resolution belongs to a lower-level feature map, and contains more environment, location and detailed information.

The number of the plurality of backbone feature maps with different resolutions may be 2, 3, 4, 5 or more, which are not enumerated herein. In at least two backbone feature maps with different resolutions, the backbone feature map with the lowest resolution is a high-level backbone feature map, and the remaining backbone feature maps with a resolution higher than that of the high-level backbone feature map are low-level backbone feature maps. For example, the number of the plurality of backbone feature maps is two, wherein the backbone feature map with a higher resolution is a low-level backbone feature map, and the backbone feature map with a lower resolution is a high-level backbone feature map. For another example, the down-sampling processing is performed on the image to be recognized 3 times, 4 times and 5 times to obtain a backbone feature map C3, a backbone feature map C4 and a backbone feature map C5, respectively. Assuming that the width and height of the feature map are [W/a, H/b], W and H are the width and height of the image to be recognized, respectively, and a and b are natural numbers, then the width and height of the backbone feature map C3 is [W/8, H/8], the width and height of the backbone feature map C4 is [W/16, H/16], and the width and height of the backbone feature map C5 is [W/32, H/32], wherein the resolution of the backbone feature map C5 is the lowest and the level is the highest, so that the backbone feature map C5 is a high-level backbone feature map, and accordingly the backbone feature map C4 and the backbone feature map C3 are both low-level backbone feature maps.

In this embodiment, the pedestrian detection network includes a first converged network and a first task head network. The first converged network is used for converging a high-level feature map and a low-level feature map output by the backbone network to obtain a converged feature map, so as to converge the stronger semantic information advantage of the high-level feature map and the richer detailed information advantage of the low-level feature map, and enable the pedestrian detection network to focus on targets with different resolution scales simultaneously.

The first task head network is configured to acquire a predicted pedestrian location according to the converged feature map, wherein the predicted pedestrian location includes a predicted pedestrian score and predicted pedestrian localization. The predicted pedestrian score represents the probability that the target feature is a pedestrian, the higher the predicted pedestrian score is, the greater the probability that the target feature is a pedestrian is, and if the predicted pedestrian score is 0, the predicted pedestrian score represents that the target feature is not a pedestrian. The predicted pedestrian localization represents the location of the target feature, if the target feature is a pedestrian, the predicted pedestrian localization represents the location of the target pedestrian. In one example, in the case where the predicted pedestrian score is greater than a preset pedestrian score threshold, the target feature is determined as a pedestrian, and the output predicted pedestrian location is the location of the target pedestrian; and in the case where the predicted pedestrian score is less than or equal to the preset pedestrian score threshold, the target feature is determined as a non-pedestrian, and the location of the target feature is not output.

Accordingly, in this embodiment, step 04: acquiring a predicted pedestrian location according to the input backbone feature map based on the pedestrian detection network, includes:
Step 041: converging at least two backbone feature maps with different resolutions based on the first converged network to acquire a plurality of first converged feature maps, the plurality of first converged feature maps having different resolutions; and
Step 042: acquiring the predicted pedestrian location according to the plurality of first converged feature maps input based on the first task head network.

Correspondingly, the location prediction module 14 may also be configured for executing the methods in steps 041 and 042. Namely, the location prediction module 14 may also be configured to converge at least two backbone feature maps with different resolutions based on the first converged network to acquire a plurality of first converged feature maps, the plurality of first converged feature maps having different resolutions; and acquire the predicted pedestrian location according to the plurality of first converged feature maps input based on the first task head network.

Referring to FIG. 2, in one example, the first converged network is a Feature Pyramid Network (FPN), and the first converged network may converge the feature maps with different resolution scales to retain the information of high-level features and low-level features. In one example, the backbone feature map C5, the backbone feature map C4 and the backbone feature map C3 with different resolutions are input into the first converged network, and the first converged network converges the above three feature maps by means of element addition to acquire a first converged feature map Pdet₅, wherein the resolution of the first converged feature map P_{det5} is the same as the resolution of the backbone feature map C5, which is [W/32, H/32]. A first converged feature map P_{det4} may be acquired by performing up-sampling processing on the first converged feature map P_{det5}, wherein the resolution of the first converged feature map P_{det4} is the same as the W resolution of the backbone feature map C4, which is [W/16, H/16]. A first converged feature map P_{det3} may be acquired by performing up-sampling processing on the first converged feature map P_{det4}, wherein the resolution of the first converged feature map P_{det3} is the same as the resolution of the backbone feature map C3, which is [W/8, H/8]. In yet another example, the first converged network converges the backbone feature map C5, the backbone feature map C4 and the backbone feature map C3 by means of element addition, and outputs the first converged feature map P_{det3}, the first converged feature map P_{det4}, and the first converged feature map P_{det5} simultaneously, the resolution of the first converged feature map P_{det3} is the same as the resolution of the backbone feature map C3, which is [W/8, H/8], the resolution of the first converged feature map P_{det4} is the same as the resolution of the backbone feature map C4, which is [W/16, H/16], and the resolution of the first converged feature map P_{det5} is the same as the resolution of the backbone feature map C5, which is [W/32, H/32].

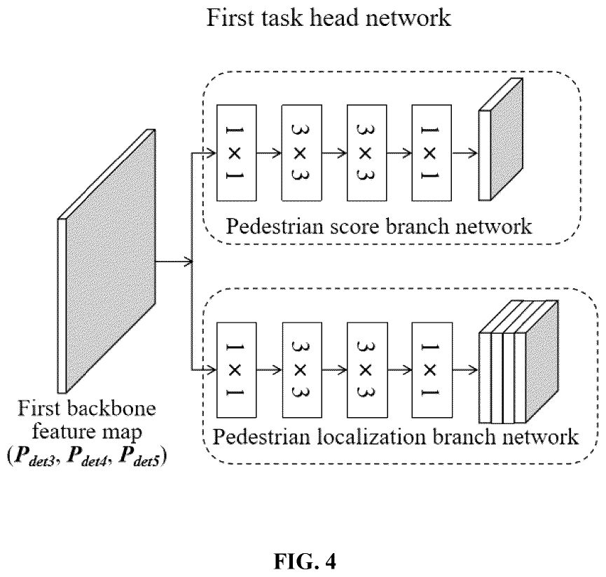

Referring to FIG. 4, in this embodiment, the first task head network includes a pedestrian score branch network and a pedestrian localization branch network. Both the pedestrian score branch network and the pedestrian localization branch network take the first converged feature map as input, and respectively output a predicted pedestrian score and predicted pedestrian localization to take the predicted pedestrian score and the predicted pedestrian localization as the output predicted pedestrian location.

In one example, the pedestrian score branch network includes four convolution layers Conv1, Conv2, Conv3, and Conv4, wherein a convolution kernel of the convolution layer Conv1 has a size of 1×1, and the function of the convolution layer Conv1 is to compress the number of network channels so as to reduce the calculation amount and save the calculation resources. Convolution kernels of the convolution layer Conv2 and the convolution layer Conv3 have a size of 3×3, a convolution kernel of the convolution layer Conv4 has a size of 1×1, the number of final output channels is 1, and the channel corresponds to a pedestrian label class. The pedestrian localization branch network includes four convolution layers Conv5, Conv6, Conv7, and Conv8, wherein a convolution kernel of the convolution layer Conv5 has a size of 1×1, and the function of the convolution layer Conv5 is to compress the number of network channels so as to reduce the calculation amount and save the calculation resources. Convolution kernels of the convolution layer Conv6 and the convolution layer Conv7 have a size of 3×3, a convolution kernel of the convolution layer Conv8 has a size of 1×1, the number of final output channels is 4, and the 4 channels correspond to coordinates of four angular points of a detection box.

In the above example, on the basis that a plurality of backbone feature maps include the backbone feature map C5, the backbone feature map C4 and the backbone feature map C3 with different resolutions, the three converged feature maps, namely, the first converged feature map P_{det3}, the first converged feature map P_{det4} and the first converged feature map P_{det5} may be acquired by inputting the above three feature maps into the first converged network, the first task head network may output a predicted pedestrian location based on the above three converged feature maps, wherein the predicted pedestrian location includes a predicted pedestrian score and predicted pedestrian localization. In other examples, it may not be limited to acquiring the three backbone feature maps by the backbone network to output the predicted pedestrian location by converging the three backbone feature maps, and 2, 4, 5 or more backbone feature maps may also be acquired by the backbone network according to settings for acquiring a converged feature, which is not limited herein.

Referring to FIG. 2, in this embodiment, the attribute recognition network includes a second converged network and a second task head network. The function of the second converged network is similar to that of the first converged network, and is used for converging at least two backbone feature maps with different resolutions output by the backbone network to obtain a converged feature map, so as to converge the stronger semantic information advantage of the high-level feature map and the richer detailed information advantage of the low-level feature map, and enable the attribute recognition network to simultaneously focus on targets with different resolution scales. The second task head network is used for acquiring a predicted pedestrian attribute according to the converged feature map.

Accordingly, in this embodiment, step 05: acquiring a predicted pedestrian attribute according to the input backbone feature map based on the attribute recognition network, includes:
Step 051: converging at least two backbone feature maps with different resolutions based on the second converged network to acquire a plurality of second converged feature maps, the plurality of second converged feature maps having different resolutions; and
Step 052: acquiring the predicted pedestrian attribute according to the plurality of second converged feature maps input based on the second task head network.

Correspondingly, the attribute prediction module 15 may also be configured for executing the methods in steps 051 and 052. Namely, the attribute prediction module 15 may also be configured to converge at least two backbone feature maps with different resolutions based on the second converged network to acquire a plurality of second converged feature maps, the plurality of second converged feature maps having different resolutions; and acquire the predicted pedestrian attribute according to the plurality of second converged feature maps input based on the second task head network.

Both the second converged network and the first converged network take the backbone feature maps in the same number as input, and in this way, the attribute recognition network and the pedestrian detection network share the backbone feature maps output by the backbone network, thereby saving hardware resources and improving the detection efficiency.

In one example, the second converged network is an FPN network, and a structure of the second converged network is substantially the same as that of the first converged network, with the difference that numerical values of network weights are different. In the case where a plurality of backbone feature maps output by the backbone network include the backbone feature map C5, the backbone feature map C4 and the backbone feature map C3, the above three feature maps are input into the second converged network, and the second converged network converges the above three feature maps to output a second converged feature map Pₚₐᵣ₃, a second converged feature map Pₚₐᵣ₄ and a second converged feature map Pₚₐᵣ₅, wherein the resolution of the second converged feature map Pₚₐᵣ₃ is the same as the resolution of the backbone feature map C3, which is [W/8, H/8], the resolution of the second converged feature map Pₚₐᵣ₄ is the same as the resolution of the backbone feature map C4, which is [W/16, H/16], and the resolution of the second converged feature map Pₚₐᵣ₅ is the same as the resolution of the backbone feature map C5, which is [W/32, H/32].

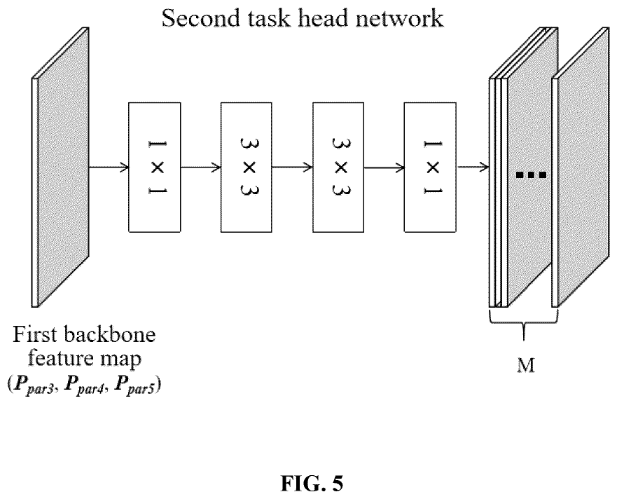

Referring to FIG. 5, in one example, the second task head network includes four convolution layers Conv9, Conv10, Conv11, and Conv12, wherein a convolution kernel of the convolution layer Conv9 has a size of 1×1, and the function of the convolution layer Conv9 is to compress the number of network channels so as to reduce the calculation amount and save the calculation resources. Convolution kernels of the convolution layer Conv10 and the convolution layer Conv11 have a size of 3×3, a convolution kernel of the convolution layer Conv12 has a size of 1×1, the number of final output channels is M, and the number of M depends on the number of classes of pedestrian attribute labels. For example, human attribute labels include 11 classes which respectively represent scores of attributes such as male, female, youth, elderly, wearing a hat, a backpack, a long-sleeved upper garment, a short-sleeved upper garment, a skirt, pants, and shorts. The classes of the pedestrian attribute labels may be customized and set, for example, the attributes such as the body orientation (front, side, and back) of the pedestrian, whether to wear glasses, whether to wear accessories, whether to hold items, the dressing style of the upper garment, and the dressing style of the lower garment may also be set as the pedestrian attribute labels.

In summary, in the above example, on the basis that a plurality of backbone feature maps include the backbone feature map C5, the backbone feature map C4 and the backbone feature map C3 with different resolutions, the pedestrian detection network acquires the three converged feature maps, namely, the first converged feature map P_{det3}, the first converged feature map P_{det4} and the first converged feature map P_{det5} based on the above three feature maps, so as to output the predicted pedestrian location based on the above three converged feature maps. Furthermore, the attribute recognition network also acquires three converged feature maps, namely, a second converged feature map Pₚₐᵣ₃, a second converged feature map Pₚₐᵣ₄ and a second converged feature map Pₚₐᵣ₅ based on the above three feature maps as input so as to output a predicted pedestrian attribute based on the above three converged feature maps. In this way, the pedestrian detection network and the attribute recognition network share the feature maps output by the backbone network to acquire the predicted pedestrian location and the predicted pedestrian attribute in parallel, so that the device resources required for calculation may be saved and the detection efficiency may be improved.

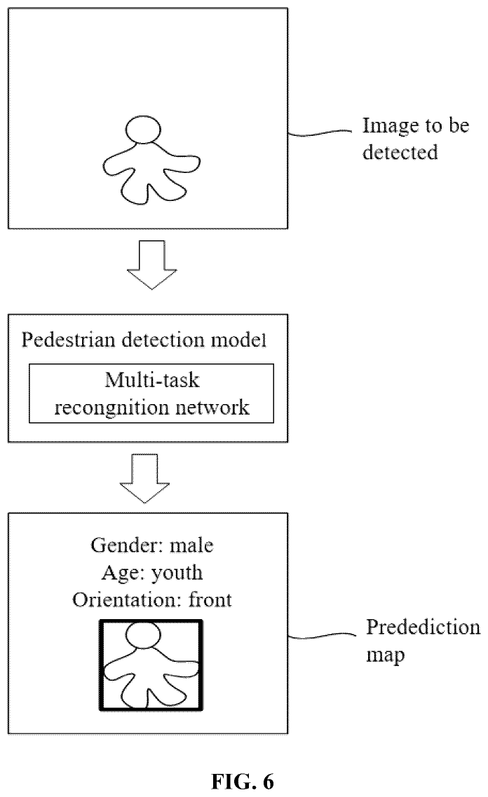

Referring to FIG. 6, in this embodiment, a multi-task recognition network correlates the predicted pedestrian location and the predicted pedestrian attribute to output a prediction map, and the prediction map contains a visualized detection result. For example, the pedestrian location is selected in the form of a detection box, and the pedestrian attribute is annotated in the form of a textual annotation in the correlated detection box.

In some embodiments, step 06 of the pedestrian detection method: correlating the predicted pedestrian location and the predicted pedestrian attribute to output a detection result, includes:
Step 061: outputting the detection box in the case where the predicted pedestrian score is greater than a preset pedestrian score; and
Step 062: outputting the visible attribute in the case where the predicted attribute score is greater than a preset attribute score.

In conjunction with FIG. 3, correspondingly, the output module 16 may also be configured for executing the methods in steps 061 and 062. Namely, the output module 16 may also be configured to output the detection box in the case where the predicted pedestrian score is greater than the preset pedestrian score; and output the visible attribute in the case where the predicted attribute score is greater than the preset attribute score.

In conjunction with the foregoing, the first task head network may acquire the predicted pedestrian score, determine a target feature as a pedestrian in the case where the predicted pedestrian score is greater than the preset pedestrian score threshold, and output a predicted location of the pedestrian, wherein the predicted location of the pedestrian is within the range of the detection box, and the detection box may be generated according to the coordinates of angular points output by the pedestrian localization branch network. The first task head network may further acquire a predicted attribute score corresponding to each attribute label, and output the attribute label as a visible attribute in the case where a certain attribute represents the corresponding predicted attribute score, and the visible attribute may be output in the form of a text annotation. For example, in the case where the predicted attribute score corresponding to the “male” label is greater than the preset attribute score and the predicted attribute score corresponding to the “female” label is less than the preset attribute score, the text annotation “male” is output.

In yet another embodiment, the visible attribute under the class label may be output according to the highest predicted attribute score in the same attribute class. For example, the “gender” class label includes “male” and “female”, and the text annotation “male” is output in the case where the predicted attribute score of “male” is greater than the predicted attribute score of “female”.

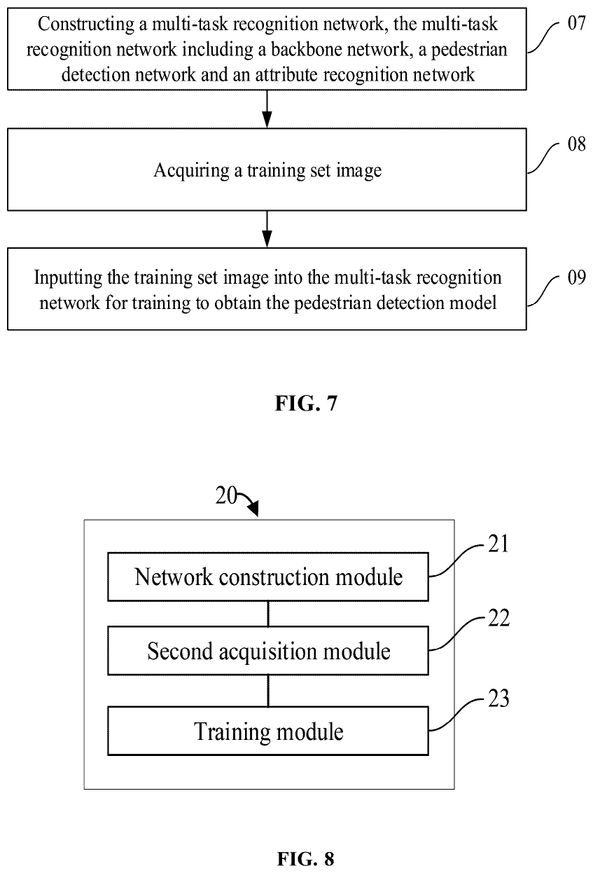

Referring to FIG. 7, this application further provides a method for training a pedestrian detection model for training the pedestrian detection model, and the trained pedestrian detection model is used for the pedestrian detection method according to an embodiment of this application. In conjunction with FIG. 6, in this embodiment, the pedestrian detection model includes a multi-task recognition network, and the multi-task recognition network in step 02 of the pedestrian detection method of this application is a multi-task recognition network in the trained pedestrian detection model. Namely, step 02 of the pedestrian detection method of this application is equivalent to: inputting an image to be recognized into the trained pedestrian detection model to acquire a predicted pedestrian location and a predicted pedestrian attribute in parallel.

The method for training a pedestrian detection model includes:
Step 07: constructing a multi-task recognition network, the multi-task recognition network including a backbone network, a pedestrian detection network and an attribute recognition network;
Step 08: acquiring a training set image; and
Step 09: inputting the training set image into the multi-task recognition network for training to obtain the pedestrian detection model;
wherein the backbone network is used for acquiring a backbone feature map according to the input training set image, the pedestrian detection network is used for acquiring a predicted pedestrian location according to the input backbone feature map, and the attribute recognition network is used for acquiring a predicted pedestrian attribute according to the input backbone feature map.

In conjunction with FIG. 8, this application further provides an apparatus 20 for training a pedestrian detection model. The apparatus for training a pedestrian detection model includes a network construction module 21, a second acquisition module 22 and a training module 23. The network construction module 21 is configured to construct a multi-task recognition network, and the multi-task recognition network includes a backbone network, a pedestrian detection network and an attribute recognition network. The second acquisition module 22 is configured to acquire a training set image. The training module 23 is configured to input the training set image into the multi-task recognition network for training to obtain the pedestrian detection model.

In this embodiment, a plurality of images may be acquired by means of video sampling to constitute an image data set, pedestrian targets in the image data set are labeled to acquire a pedestrian location detection box and a pedestrian attribute label of each image in the image data set, and the images in the image data set are randomly divided into a training set, a verification set and a testing set in a predetermined proportion. For example, the data set may be randomly divided into the training set, the validation set and the testing set in a proportion of 8:1:1.

In this embodiment, prior to inputting the training set image into the multi-task recognition network, data enhancement processing may be performed on the training set image to enhance pedestrian features. The training set image after being subjected to data enhancement is then input into the multi-task recognition network. The method for data enhancement may be a Mosaic method, an Autoagument method, a rand earasing method, and the like, which is not limited herein.

The training set image is input into the multi-task recognition network for training, and a preset parameter in the multi-task recognition network may be acquired by means of back propagation according to a training result, so that the preset parameter of the multi-task recognition network may be tested by utilizing the testing set image in the subsequent step. In one example, the training for the multi-task recognition network is completed in the case where the preset parameter of the multi-task recognition network satisfies a testing index, and the pedestrian detection model is obtained based on the parameter, for example, the pedestrian detection model is obtained in the case where the testing set index no longer rises. In yet another example, the pedestrian detection model may be obtained in the case where the cumulative number of times of training for the multi-task recognition network reaches a preset number of times. The above example in which the pedestrian detection model is obtained is not limited.

In some embodiments, step 09: inputting the training set image into the multi-task recognition network for training to obtain the pedestrian detection model, includes:
Step 091: acquiring a training location feature map and a training attribute feature map based on the input training set image;
Step 092: calculating total loss according to the training location feature map and the training attribute feature map; and
Step 093: updating preset parameters of the pedestrian detection model according to the total loss to obtain the pedestrian detection model.

Accordingly, the training module 23 may also be configured for executing the methods in steps 091, 092, and 093. Namely, the training module 23 may be configured to acquire the training location feature map and the training attribute feature map based on the input training set image; calculate the total loss according to the training location feature map and the training attribute feature map; and update the preset parameters of the pedestrian detection model according to the total loss to obtain the pedestrian detection model.

During the first training, the multi-task recognition network has initial preset parameters. By calculating the total loss of the multi-task recognition network, the preset parameters of the multi-task recognition network may be updated by means of back propagation so as to adopt the updated preset parameters for training during the next training. The multi-task recognition network may acquire the training location feature map and the training attribute feature map based on the input training set image, may calculate a loss function related to pedestrian localization according to the training location feature map and may calculate a loss function related to a pedestrian attribute according to the training attribute feature map in conjunction with the labeled pedestrian target in the verification set image, and may combine the loss function related to the pedestrian localization and the loss function related to the pedestrian attribute to obtain the total loss of the multi-task recognition network. In one example, the multi-task recognition network may be trained by a gradient descent method based on the total loss of the multi-task recognition network to update the preset parameters of the multi-task recognition network. When a testing set index acquired by testing the multi-task recognition network by adopting the testing set no longer rises, the latest preset parameters of the multi-task recognition network are reserved to complete the training for the pedestrian detection model.

In this embodiment, step 092: calculating total loss according to the training location feature map and the training attribute feature map, includes:
Step 0921: determining a positive sample in the training location feature map, the positive sample including a pedestrian location box;
Step 0922: calculating pedestrian classification loss and pedestrian localization loss according to the positive sample;
Step 0923: calculating pedestrian attribute loss according to the pedestrian location box and the training attribute feature map; and
Step 0924: calculating the total loss according to the pedestrian classification loss, the pedestrian localization loss and the pedestrian attribute loss.

In conjunction with FIG. 8, accordingly, the training module 23 may also be configured for executing the methods in steps 0921, 0922, 0923, and 0924. Namely, the training module 23 may be configured to determine the positive sample in the training location feature map, the positive sample including the pedestrian location box. The training module 23 may further be configured to calculate pedestrian classification loss and pedestrian localization loss according to the positive sample, calculate pedestrian attribute loss according to the pedestrian location box and the training attribute feature map, and calculate the total loss according to the pedestrian classification loss, the pedestrian localization loss and the pedestrian attribute loss.

In one example, an anchor-free method may be adopted for training the pedestrian detection model, and classification and regression are performed based on a candidate region (such as a location box). Compared with a conventional anchor method, the anchor-free method does not require complex anchor design and a non-maximum suppression strategy by regressing a center point and the width and height of the target feature of feature maps with different resolution scales, thereby saving the device resources required for calculation and improving the detection efficiency. Furthermore, the anchor-free method does not need to consider a rotation angle attribute of the feature, and may be applicable to the pedestrian detection for the fisheye image with a certain degree of rotational distortion.

The pedestrian target feature is selected in the form of a pedestrian location box in the positive sample which represents a location box having a pedestrian target within the selection range. A negative sample, as opposed to the positive sample, represents a location box having no pedestrian target within the selection range. If the location box corresponding to the target feature is the positive sample, the predicted pedestrian score corresponding to the target feature is an intersection over union of the pedestrian location box and a label location box of the pedestrian target in the verification set image. If the location box corresponding to the target feature is the negative sample, the predicted pedestrian score corresponding to the target feature is 0. The pedestrian classification loss is used for measuring the difference between the pedestrian prediction score and the target score, and the pedestrian classification loss may be calculated by adopting functions such as a BCEloss function, a Focal loss function, a varifocal loss function, and a quality focal loss function, which are not limited herein. The pedestrian localization loss is used for measuring the location difference between the prediction box and the label box, and the pedestrian localization loss may be calculated by adopting target box regression loss functions such as a ciou loss function, a GIOU loss function, a DIOU Loss function, and an SIOU Loss function, which are not limited herein.

According to a location of the pedestrian location box of the positive sample, a predicted pedestrian attribute corresponding to the location is extracted from the training attribute feature map output by the second task head network to calculate the pedestrian attribute loss, the corresponding predicted pedestrian attribute includes a predicted result value, a target score value, a target intersection over union and a target proportion, the predicted result value represents a pedestrian attribute probability, the target score value represents a pedestrian attribute probability in the label of the training set image, the target intersection over union is an intersection over union of the pedestrian location box and the label location box of the training set image, and the target proportion represents the proportion of the positive sample corresponding to the jth pedestrian attribute in the training set image. The pedestrian attribute loss is set to be L_{PAR}, and the pedestrian attribute loss L_{PAR} may be calculated according to the pedestrian attribute loss function. The pedestrian attribute loss function includes:

$$Equation 1$$

$${L}_{PAR} = - {\sum }_{j = 1}^{M} {W}_{1} * {W}_{2} * [ targets * log ( σ ( pred ) ) + ( 1 - targets ) * log ( 1 - σ ( pred ) ) ] ;$$

$${W}_{1} = α * {σ ( pred )}^{γ} * ( 1 - targets ) + IOU * targets ; \qquad Equation 2$$

$$and$$

$${W}_{2} = \{ \begin{matrix}{e}^{1 - {r}_{j}} & , targets = 1 \\ {e}^{{r}_{j}} & , targets = 0\end{matrix} . \qquad Equation 3$$

In Equation 1, pred is the predicted result value of the attribute recognition network; σ is a preset activation function, for example, σ may be a sigmoid activation function, which is not limited herein. σ is used for mapping the predicted result value of the attribute recognition network into a range of [0, 1], so that the predicted result value of the attribute recognition network represents the predicted pedestrian attribute score; targets is the target score in the label, and the value of targets is 0 or 1; and IOU is the target intersection over union of the pedestrian location box and the label location box, and M is the number of classes of human attributes which need to be recognized. In Equation 2 and Equation 3, α and γ are preset adjustable hyperparameters, and rⱼ is the target proportion.

As shown in Equation 2, in the case where the value of targets is 1, IOU is proportional to the value of W₁. In this way, the pedestrian detection model is more focused on a high-quality predicted location box. In the case where the value of targets is 0, an output value of α*sigmoid(pred)^{γ} is positively correlated with pred, namely, the higher the score of the predicted result value of the attribute recognition network is, the greater the loss weight is, and the higher an error penalty of the pedestrian detection model is. In this way, a partition strategy of the attribute recognition network of the pedestrian detection model is more cautious, and the accuracy of the pedestrian detection model is improved.

In some embodiments, the preset parameters include a weight of a detection task and a weight of a pedestrian attribute recognition task. Assuming that the pedestrian classification loss is L_{cls}, the pedestrian location loss is L_{ciou}, and the total loss is Lₜₒₜₐₗ, the total loss Lₜₒₜₐₗ may be calculated according to a loss function corresponding to the total loss. The loss function corresponding to the total loss includes:

$${L}_{total} = {e}^{- {W}_{det}} * ( {L}_{cls} + {L}_{ciou} ) + {e}^{- {W}_{PAR}} * {L}_{PAR} + ( {W}_{det} + {W}_{PAR} ) . \qquad Equation 4$$

In Equation 4, W_{det} represents the weight of the detection task, W_{PAR} represents the weight of the pedestrian attribute recognition task, and both W_{det} and W_{PAR} are parameters which may be learned in a back propagation process of the network.

In some embodiments, a simOTA algorithm may be adopted to output a linear assignment result corresponding to the location box, and an intersection over union of the location box and the label location box, so as to determine whether the location box is a positive sample or a negative sample according to the linear assignment result. Accordingly, step 0921: determining a positive sample in the training location feature map, includes:
Step 09211: acquiring a training location box according to the training location feature map;
Step 09212: acquiring a label location box according to a verification set image;
Step 09213: calculating an intersection over union of the training location box and the label location box;
Step 09214: determining a positive sample quantity value according to the intersection over union;
Step 09215: determining a positive sample candidate region based on a center prior, and calculating a cost matrix corresponding to the positive sample candidate region; and
Step 09216: determining the positive sample according to the cost matrix and the positive sample quantity value.

Correspondingly, the training module 23 is configured for executing the methods in steps 09211, 09212, 09213, 09214, 09215, and 09216. Namely, the training module 23 is further configured to determine the positive sample in the training location feature map, wherein the positive sample includes the pedestrian location box. The training module 23 may further be configured to calculate pedestrian classification loss and pedestrian localization loss according to the positive sample, calculate pedestrian attribute loss according to the pedestrian location box and the training attribute feature map, and calculate the total loss according to the pedestrian classification loss, the pedestrian localization loss and the pedestrian attribute loss.

The training location box is a location box corresponding to the predicted pedestrian location in the training location feature map, the label location box is a location box of the pedestrian target in the verification set image, and in the case where a plurality of pedestrian targets are present in the verification set image, different pedestrian targets correspond to different labels. The intersection over union calculated in step 09213 includes the intersection over union of each label location box and each training location box. For example, the number of labels is 2, the labels include a first label and a second label, the number of training location boxes is 2, and the training location boxes include a first training location box and a second training location box, then the intersection over union iou−1 of the first label and the first training location box, the intersection over union iou−2 of the first label and the second training location box, the intersection over union iou−3 of the second label and the first training location box, and the intersection over union iou−4 of the second label and the second training location box are calculated, respectively.

The positive sample quantity value refers to the quantity value of positive samples which need to be assigned to each label. In one example, in the intersection over union corresponding to each label, according to the magnitude of the intersection over unions, the first n maximum intersection over unions are summed and rounded down to obtain the quantity value of positive samples which need to be assigned to each label.

According to the training location feature map, a candidate region of the positive sample may be determined by adopting a center prior method so as to determine the positive sample by utilizing a cost matrix. In one example, the quantity value of positive samples is set to be k, and the cost matrix corresponding to each training location box is calculated in the candidate region. The larger the cost matrix is, the larger the cost of selecting the training location box corresponding to the matrix as the positive sample is. Based on this, the first k training location boxes with the minimum cost matrixes are selected as the positive samples for each label, and the remaining training location boxes are taken as the negative samples to determine the positive samples. In the case where the training location box is determined as the positive sample, the coordinate of the training location box is the coordinate of the pedestrian location box in step 09211.

If a certain training location box is the positive sample, the location of the positive sample in the training location feature map, the corresponding label location box and the intersection over union of the positive sample and the corresponding label location box may be obtained according to the linear assignment result of the simOTA algorithm. In this way, each label often corresponds to a plurality of positive samples, and in conjunction with the foregoing, when calculating the pedestrian attribute loss, the location of the pedestrian attribute feature is extracted in the training attribute feature map as the location of the positive sample, thereby facilitating an increase in the number of pedestrian attribute features participating in back propagation.

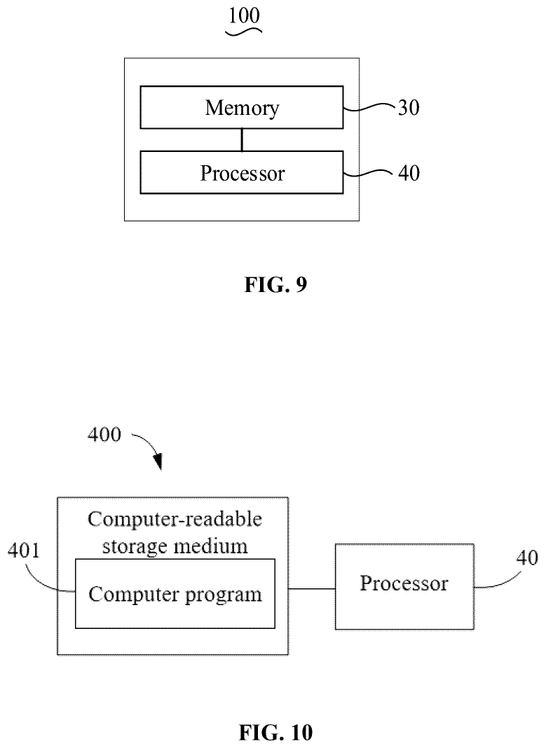

FIG. 9 is an electronic device 100 according to an embodiment of this application. The electronic device 100 includes a memory 30 and a processor 40. The memory 30 is configured to store a computer program including a plurality of computer program instructions, and the processor 40 may be configured to execute the computer program instructions stored in the memory 30 to perform steps of the pedestrian detection method in the above embodiments, for example, execute the pedestrian detection method in steps 01, 02, 03, 04, 05, and 06 in the above embodiments. The processor 40 may also be configured to execute the computer program instructions stored in the memory 30 to perform steps of the method for training a pedestrian detection model in the above embodiments, for example, execute the method for training a pedestrian detection model in steps 07, 08, and 09 in the above embodiments.

Wherein the electronic device 100 includes, but is not limited to, a cell phone, a camera, a video camera, a notebook computer, a tablet computer, a smart watch, a monitoring device, an unmanned aerial vehicle, an unmanned vehicle, a smart furniture device, and the like.

Referring to FIG. 10, an embodiment of this application further provides a non-transitory computer-readable storage medium 400 having a computer program 401. The computer program 401 includes a plurality of computer program instructions. When the computer program 401 is executed by one or more processors 40, the one or more processors 40 are caused to execute the pedestrian detection method according to any one of the above embodiments, for example, execute the pedestrian detection method in steps 01, 02, 03, 04, 05, and 06 in the above embodiments; and the one or more processors 40 may also be caused to execute the method for training a pedestrian detection model according to any one of the above embodiments, for example, execute the method for training a pedestrian detection model in steps 07, 08, and 09 in the above embodiments.

In the description of this specification, the description with reference to the terms such as “embodiments”, “in one example”, and “exemplarily” means that a particular feature, structure, material, or characteristic described in conjunction with the embodiments or examples is included in at least one embodiment or example of this application. In this specification, schematic expressions of the above terms do not necessarily refer to the same embodiment or example. Furthermore, the particular feature, structure, material, or characteristic described may be combined in a suitable manner in any embodiment or example. In addition, incorporation and combination of different embodiments or examples and features of the different embodiments or examples described in this specification may be made by those skilled in the art without contradicting each other.

Any process or method described in a flowchart or otherwise described herein may be understood to represent a module, segment, or portion which includes one or more codes of executable instructions for implementing the steps of a particular logical function or process, and the scope of the preferred embodiments of this application includes additional implementations, wherein functions may be executed in substantially the same way or in a reverse order according to the involved functions, but not in the order illustrated or discussed, as will be understood by those skilled in the art to which the examples of this application pertain.

While the embodiments of this application have been shown and described above, it will be understood that the above embodiments are exemplary and are not to be construed as limiting this application, and variations, modifications, substitutions, and alterations to the above embodiments may be made by those ordinarily skilled in the art within the scope of this application.

What is claimed is:

1. A pedestrian detection method, comprising:
acquiring an image to be recognized;
inputting the image to be recognized into a pre-trained multi-task recognition network, the multi-task recognition network comprising a backbone network, a pedestrian detection network and an attribute recognition network;
acquiring a backbone feature map according to the input image to be recognized based on the backbone network;
acquiring a predicted pedestrian location according to the backbone feature map based on the pedestrian detection network;
acquiring a predicted pedestrian attribute according to the backbone feature map based on the attribute recognition network; and
correlating the predicted pedestrian location and the predicted pedestrian attribute to output a detection result.

2. The pedestrian detection method according to claim 1, wherein the acquiring a predicted pedestrian location according to the backbone feature map based on the pedestrian detection network, comprises:
converging at least two backbone feature maps with different resolutions based on a first converged network of the pedestrian detection network to acquire a plurality of first converged feature maps, the plurality of first converged feature maps having different resolutions; and
acquiring the predicted pedestrian location according to the plurality of first converged feature maps input based on a first task head network of the pedestrian detection network.

3. The pedestrian detection method according to claim 1, wherein the acquiring a predicted pedestrian attribute according to the backbone feature map based on the attribute recognition network, comprises:
converging at least two backbone feature maps with different resolutions based on a second converged network of the attribute recognition network to acquire a plurality of second converged feature maps, the plurality of second converged feature maps having different resolutions; and
acquiring the predicted pedestrian attribute according to the plurality of second converged feature maps input based on a second task head network of the attribute recognition network.

4. The pedestrian detection method according to claim 1, wherein the correlating the predicted pedestrian location and the predicted pedestrian attribute to output a detection result, comprises:
outputting the detection result having a detection box if a predicted pedestrian score of the predicted pedestrian location is greater than a preset pedestrian score; and
outputting the detection result having a visible attribute if a predicted attribute score of the predicted pedestrian attribute is greater than a preset attribute score.

5. A method for training a pedestrian detection model, comprising:
constructing a multi-task recognition network, the multi-task recognition network comprising a backbone network, a pedestrian detection network and an attribute recognition network;
acquiring a training set image; and
inputting the training set image into the multi-task recognition network for training to obtain the pedestrian detection model; wherein:
the backbone network is configured for acquiring a backbone feature map according to the training set image;
the pedestrian detection network is configured for acquiring a predicted pedestrian location according to the backbone feature map; and
the attribute recognition network is configured for acquiring a predicted pedestrian attribute according to the backbone feature map.

6. The method for training a pedestrian detection model according to claim 5, wherein the inputting the training set image into the multi-task recognition network for training to obtain the pedestrian detection model, comprises:
acquiring a training location feature map and a training attribute feature map based on the training set image;
calculating total loss according to the training location feature map and the training attribute feature map; and
updating preset parameters of the pedestrian detection model according to the total loss to obtain the pedestrian detection model.

7. The method for training a pedestrian detection model according to claim 6, wherein the calculating total loss according to the training location feature map and the training attribute feature map, comprises:
determining a positive sample in the training location feature map, the positive sample comprising a pedestrian location box;
calculating a pedestrian classification loss and a pedestrian localization loss according to the positive sample;
calculating pedestrian attribute loss according to the pedestrian location box, the training attribute feature map and the positive sample; and
calculating the total loss according to the pedestrian classification loss, the pedestrian localization loss and the pedestrian attribute loss.

8. The method for training a pedestrian detection model according to claim 7, wherein the calculating pedestrian attribute loss according to the pedestrian location box, the training attribute feature map and the positive sample, comprises:
acquiring a predicted result value, a target score value, a target intersection over union and a target proportion according to the pedestrian location box, the training attribute feature map and the positive sample, the predicted result value representing a pedestrian attribute probability, the target score value representing the pedestrian attribute probability in a label of the training set image, the target intersection over union being an intersection over union of the pedestrian location box and a label location box of the training set image, and the target proportion representing a proportion occupied by the positive sample corresponding to the jth pedestrian attribute in the training set image; and
calculating the pedestrian attribute loss by utilizing a pedestrian attribute loss function based on preset hyperparameters, a preset activation function, a preset number of human attribute classes, the predicted result value, the target score value and the target intersection over union;
wherein the pedestrian attribute loss function comprises:
$$Equation 1$$
$${L}_{PAR} = - {\sum }_{j = 1}^{M} {W}_{1} * {W}_{2} * [ targets * log ( σ ( pred ) ) + ( 1 - targets ) * log ( 1 - σ ( pred ) ) ] ;$$
$${W}_{1} = α * {σ ( pred )}^{γ} * ( 1 - targets ) + IOU * targets ; \qquad Equation 2$$
$$and$$
$${W}_{2} = \{ \begin{matrix}{e}^{1 - {r}_{j}} & , targets = 1 \\ {e}^{{r}_{j}} & , targets = 0\end{matrix} ; \qquad Equation 3$$
where L_{PAR} is the pedestrian attribute loss, M is the preset number of human attribute classes, targets is the target score value, σ is the preset activation function, pred is the predicted result value, α and γ are the preset hyperparameters, IOU is the target intersection over union, and rⱼ is the target proportion.

9. The method for training a pedestrian detection model according to claim 7, wherein the preset parameters comprise a weight of a detection task and a weight of a pedestrian attribute recognition task, and a loss function corresponding to the total loss comprises:
$${L}_{total} = {e}^{- {W}_{det}} * ( {L}_{cls} + {L}_{ciou} ) + {e}^{- {W}_{PAR}} * {L}_{PAR} + ( {W}_{det} + {W}_{PAR} ) ; \qquad Equation 4$$
where L_{cls} represents the pedestrian classification loss, L_{ciou} represents the pedestrian localization loss, L_{PAR} represents the pedestrian attribute loss, W_{det} represents the weight of the detection task, and W_{PAR} represents the weight of the pedestrian attribute recognition task.

10. The method for training a pedestrian detection model according to claim 7, wherein the determining a positive sample in the training location feature map, comprises:
acquiring a training location box according to the training location feature map;
acquiring a label location box according to a verification set image;
calculating an intersection over union of the training location box and the label location box;
determining a positive sample quantity value according to the intersection over union;
determining a positive sample candidate region based on a center prior, and calculating a cost matrix corresponding to the positive sample candidate region; and
determining the positive sample according to the cost matrix and the positive sample quantity value.

11. An electronic device, comprising:
a memory configured to store a plurality of computer program instructions; and
a processor coupled to the memory and configured to execute the computer program instructions stored in the memory to cause the electronic device to:
acquire an image to be recognized;
input the image to be recognized into a pre-trained multi-task recognition network, the multi-task recognition network comprising a backbone network, a pedestrian detection network and an attribute recognition network;
acquire a backbone feature map according to the input image to be recognized based on the backbone network;
acquire a predicted pedestrian location according to the backbone feature map based on the pedestrian detection network;
acquire a predicted pedestrian attribute according to the backbone feature map based on the attribute recognition network; and
correlate the predicted pedestrian location and the predicted pedestrian attribute to output a detection result.

12. The electronic device according to claim 11, wherein the processor further executes the instructions to cause the electronic device to:
converge at least two backbone feature maps with different resolutions based on a first converged network of the pedestrian detection network, to acquire a plurality of first converged feature maps, the plurality of first converged feature maps having different resolutions; and
acquire the predicted pedestrian location according to the plurality of first converged feature maps input based on a first task head network of the pedestrian detection network.

13. The electronic device according to claim 11, wherein the processor further executes the instructions to cause the electronic device to:
converge at least two backbone feature maps with different resolutions based on a second converged network of the attribute recognition network, to acquire a plurality of second converged feature maps, the plurality of second converged feature maps having different resolutions; and
acquire the predicted pedestrian attribute according to the plurality of second converged feature maps input based on a second task head network of the attribute recognition network.

14. The electronic device according to claim 11, wherein the processor further executes the instructions to cause the electronic device to:
output the detection result having a detection box if a predicted pedestrian score of the predicted pedestrian location is greater than a preset pedestrian score; and
output the detection result having a visible attribute if a predicted attribute score of the predicted pedestrian attribute is greater than a preset attribute score.

15. An electronic device, comprising:
a memory configured to store a plurality of computer program instructions; and
a processor coupled to the memory and configured to execute the computer program instructions stored in the memory to perform the method for training a pedestrian detection model according to claim 5.

16. A non-transitory computer-readable storage medium having a plurality of computer program instructions stored thereon, wherein the program instructions, when executed by one or more processors, cause the one or more processors to implement the pedestrian detection method according to claim 1.

17. A non-transitory computer-readable storage medium having a plurality of computer program instructions stored thereon, wherein the program instructions, when executed by one or more processors, cause the one or more processors to implement the method for training a pedestrian detection model according to claim 5.
